(19) United States
(12) Patent Application Publication
(10) Pub. No.: US 2021/0129269 A1
(43) Pub. Date: May 6, 2021

(54) SYSTEM AND METHOD TO ADDITIVELY FORM ONTO AN OBJECT

(71) Applicant: Commonwealth Center for Advanced Manufacturing (CCAM), Disputanta, VA (US)

(72) Inventors: Yuri Alexeyevich Plotnikov, Chesterfield, VA (US); Mark Alan White, Midlothian, VA (US); Cameron Scott Gygi, West Chester, OH (US)

(21) Appl. No.: 16/877,542

(22) Filed: May 19, 2020

Related U.S. Application Data
(60) Provisional application No. 62/928,022, filed on Oct. 30, 2019.

(51) Int. Cl. B23K 26/342; B33Y 50/00; B33Y 30/00; B23K 26/03; B23K 26/042; B23K 26/06; B23K 26/082

(52) U.S. Cl. CPC B23K 26/342; B33Y 50/00; B33Y 30/00; B29C 64/10; B23K 26/042; B23K 26/0626; B23K 26/082; B23K 26/032

(57) ABSTRACT

A system includes an optical device configured to emit light toward a build area, and an optical sensor configured to detect reflection of the light off the build area. The optical device operates at a first operating setting or at a second operating setting. The optical sensor receives reflection of the light emitted from the optical device operating at the first operating setting and reflected off the build area to determine one or more of a position, an orientation, or a shape of an object disposed on or within the build area. The optical device operates at the second operating setting to emit the light to additively form onto the object disposed on or within the build area.

### CROSS-REFERENCE TO RELATED APPLICATIONS

This application claims priority to U.S. Provisional Application Ser. No. 62/928,022, filed Oct. 30, 2019. The entire disclosure of which is incorporated herein by reference.

### FIELD

One or more embodiments are disclosed that relate to systems and methods for additive manufacturing.

### BACKGROUND

Various methods of additively manufacturing are used in several applications. In many instances, an object may be printed or formed using one of various additive manufacturing methods. Additively manufactured objects may include features that may not be possible to produce using alternative manufacturing methods, such as forming, molding, etching, etc.

However, in order to additively manufacture a component or feature onto an existing object, the position and shape of the object must be precisely known. For example, a computer aided design (CAD) model of the component to be additively form onto the existing object must have the precise physical coordinates of the object within the build area. However, in many cases, the object is placed in the build area by an operator, and therefore placement of the object is not controlled. Known systems may determine the position and shape of the object within the build area, however the systems fail to include the equipment necessary to additively form the component onto the object once the position and shape of the object are verified.

### BRIEF DESCRIPTION

In one or more embodiments, a system includes an optical device configured to emit light toward a build area, and an optical sensor configured to detect reflection of the light off one or more of the build area or an object disposed on or within the build area. The optical device operates at a first operating setting or at a second operating setting. The optical sensor receives reflection of the light emitted from the optical device operating at the first operating setting and reflected off one or more of the build area or the object to determine one or more of a position, an orientation, or a shape of the object disposed on or within the build area. The optical device operates at the second operating setting to emit the light to additively form onto the object disposed on or within the build area.

In one or more embodiments, a method includes operating an optical device of a system at a first operating setting or at a second operating setting. The system includes the optical device that emits light toward a build area, and an optical sensor that detects reflection of the light off one or more of the build area or an object disposed on or within the build area. The optical sensor receives reflection of the light emitted from the optical device operating at the first operating setting and reflected off one or more of the build area or the object to determine one or more of a position, an orientation, or a shape of the object disposed on or within the build area. The optical device operates at the second operating setting to emit the light to additively form onto the object disposed on or within the build area.

In one or more embodiments of the subject matter described herein, an optical additive manufacturing system includes an optical device configured to emit light toward a build area, and an optical sensor configured to detect reflection of the light off one or more of the build area or an object disposed on or within the build area. The optical device is configured to operate at a first operating setting or at a second operating setting. When the optical device is operating at the first operating setting, the optical device is configured to operate at a first energy level such that the optical device is configured to emit light having a first power. The optical sensor is configured to receive reflection of the light emitted from the optical device and reflected off one or more of the build area or the object to determine one or more of a position, an orientation, or a shape of the object disposed on or within the build area when the optical device is operating at the first operating setting. When the optical device is operating at the second operating setting, the optical device is configured to operate at a second energy level such that the optical device is configured to emit light having an elevated power that is greater than the first power. The optical device is configured to operate at the second operating setting to emit the light to additively form onto the object disposed on or within the build area.

### BRIEF DESCRIPTION OF THE DRAWINGS

FIG. 1 illustrates a side-wise view of a system for additive manufacture in accordance with one embodiment;

FIG. 2 illustrates a side-wise view of an alternative embodiment of an additive manufacturing system;

FIG. 3 illustrates a side-wise view of an alternative system for additive manufacturing in accordance with one embodiment;

FIG. 4 illustrates a top view of the system shown in FIG. 1 in accordance with one embodiment;

FIG. 5 illustrates a diagram of a potential workflow of operating the system shown in FIG. 1 at first operating settings in accordance with one embodiment;

FIG. 6 illustrates an example of operating a system at first operating settings in accordance with one embodiment;

FIG. 7A illustrates a sample of images of the scanning areas shown in FIG. 6 in accordance with one embodiment;

FIG. 7B illustrates one of the scanning areas shown in FIG. 7A;

FIG. 8A illustrates an alternative sample of images of the scanning areas shown in FIG. 6 in accordance with one embodiment;

FIG. 8B illustrates one of the scanning areas shown in FIG. 8A;

FIG. 9 illustrates a graph related to measuring a scanning area in accordance with one embodiment;

FIG. 10 illustrates a top view of a moving laser beam and optical sensor profile in accordance with one embodiment;

FIG. 11 illustrates a side view of the moving laser beam shown in FIG. 10; and

FIG. 12 illustrates a flowchart of a method of determining a position, an orientation, or a shape of an object disposed on or within a build area in accordance with one embodiment.

### DETAILED DESCRIPTION

One or more embodiments of the inventive subject matter described herein provide systems and methods that provide a system that may operate at least two different operating settings. The system includes an optical device, such as a laser, that emits light toward a build area, and one or more optical sensors that detect reflection of the light off the build area. While the system is operating at a first operating setting, the optical device may emit light toward the build area and the optical sensor may receive reflection of the light reflected off the build area to determine a shape, an orientation, or a position of an object that is disposed on and/or within the build area. The optical sensor may determine the shape, orientation, and/or position of the object by measuring an intensity of the reflection of the light and from laser scanning velocity and correlating that to a known and/or calculated spatial coordinate. Subsequent to determining the shape, orientation, and/or position of the object, the system may operate at a second operating setting to additively form onto the object. For example, the system may additively form a component or feature onto the object to generate a unitary piece of the object and the component.

At least one technical effect of the various embodiments herein can provide precise determination of the position, shape, or orientation of the object that may be disposed within and/or on the build area. In order to additively form the component onto the object, the exact position of the object on the build area must be known. The systems and methods described herein include a single or unitary system that can perform the operations of accurately determining the position and/or shape of the object, and additively form the component onto the object once the position and shape of the object are known.

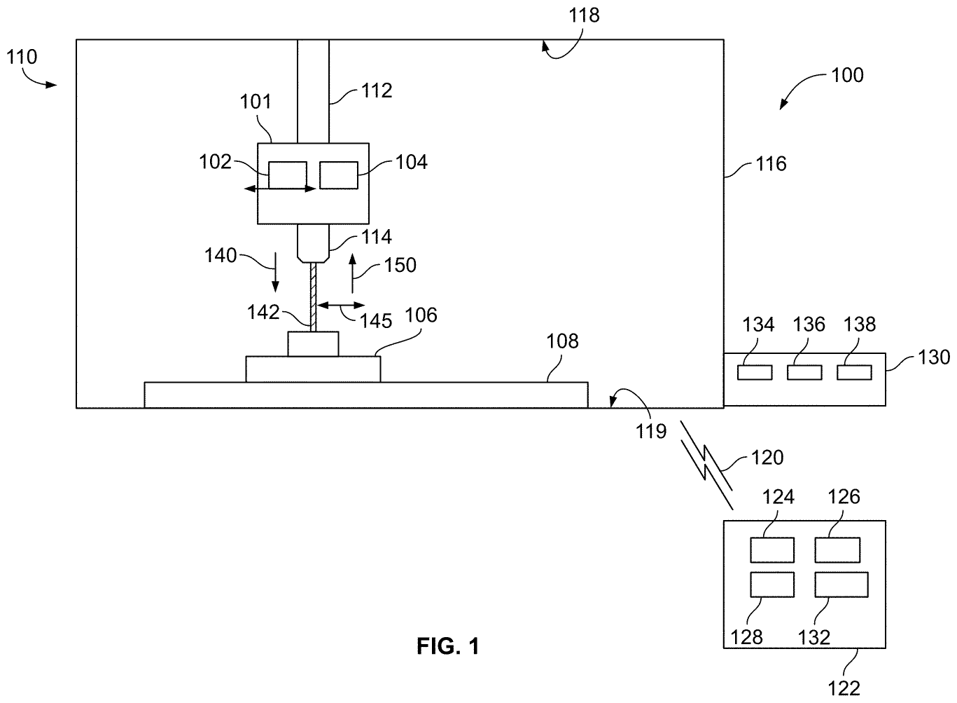

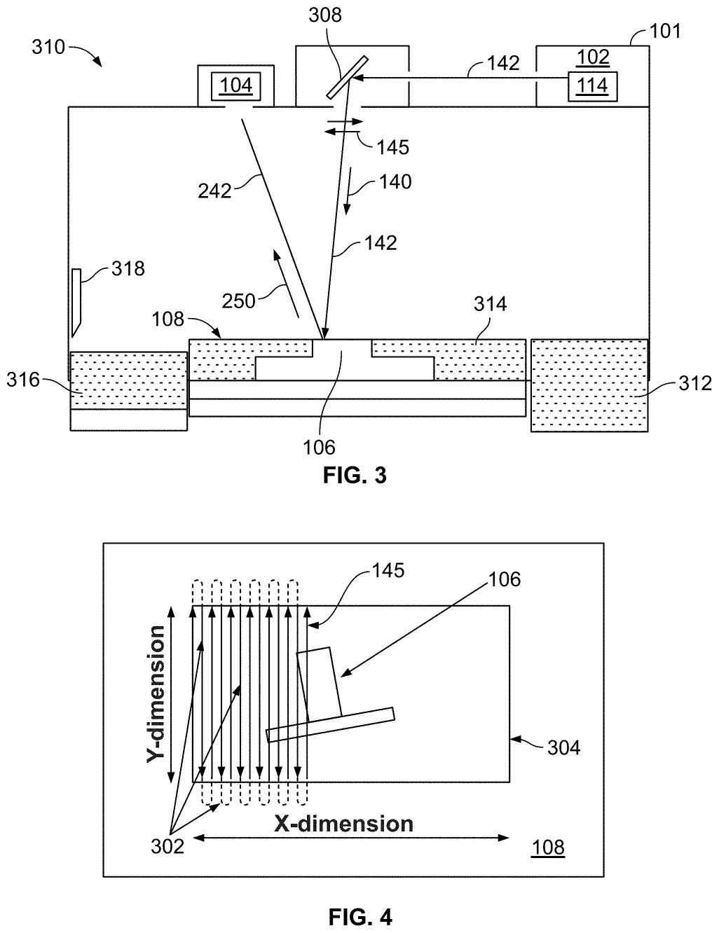

FIG. 1 illustrates a side-wise view of a system 100 for additive manufacture in accordance with one embodiment. The system 100 includes an additive manufacturing system 110 that includes a laser head 101 and a build area 108 disposed within a housing 116. The laser head 101 is coupled with a surface 118 of the housing 116 via an arm 112. The arm 112 may be a movable arm, such that the arm 112 may move in different directions to move the laser head 101 to one or more positions within the housing 116. Alternatively, the head may be coupled with any alternative surface of the housing 116 via one or more different arms 112 to enable the laser head 101 to move in at least three different directions. For example, FIG. 3 illustrates an alternative system that may be referred to herein as a galvanometer-based scan system that does not include a moving laser head 101. FIG. 3 will be described in more detail below.

The system 110 includes an optical device 102 and at least one optical sensor 104 disposed within the head 101. The optical sensor 104 may be a photosensor or any other type of photodetector. The laser head 101 also includes a laser source 114 that is operably coupled with the optical device 102. The optical device 102 emits light 142 in a direction 140 toward the build area 108. The direction 140 may also be referred to herein as an energy deposition direction that refers to a direction at which energy is deposited from the optical device 102. Reflected light that is a reflection of the emitted light 142 is reflected off of the build area 108 and off of an object 106 in a reflection direction 150 toward the optical sensor 104. In one or more embodiments, the optical sensor 104 may operate at a high or elevated sampling frequency, and the optical device 102 may emit the light 142 onto the build area 108 at a substantially constant scanning velocity. As one example, the sampling frequency may be from about 0.5 megahertz (MHz) to about 10 MHz. Optionally, the sampling frequency may be less than or smaller than 0.5 MHz, and/or may be greater than 10 MHz. Optionally, the sampling frequency range may be greater than or less than about 0.5 MHz to about 10 MHz. For example, the ranges may be from about 0.5 MHz to about 20 MHz, or to about 50 MHz, or the like. Optionally, the optical device 102 may emit the light at a non-constant scanning velocity, or at a combination of constant and non-constant scanning velocities.

The object 106 may be disposed on and/or within the build area 108. For example, the object 106 may be positioned on a surface of the build area 108. Optionally, a portion of the object 106 may be disposed within the build area 108 and another portion of the object 106 may be disposed outside of the build area 108. Optionally, the object 106 may be disposed on another component that is disposed on a surface of the build area 108. Optionally, the object 106 may be suspended above a surface of the build area 108 but within a three-dimensional volume of the build area 108.

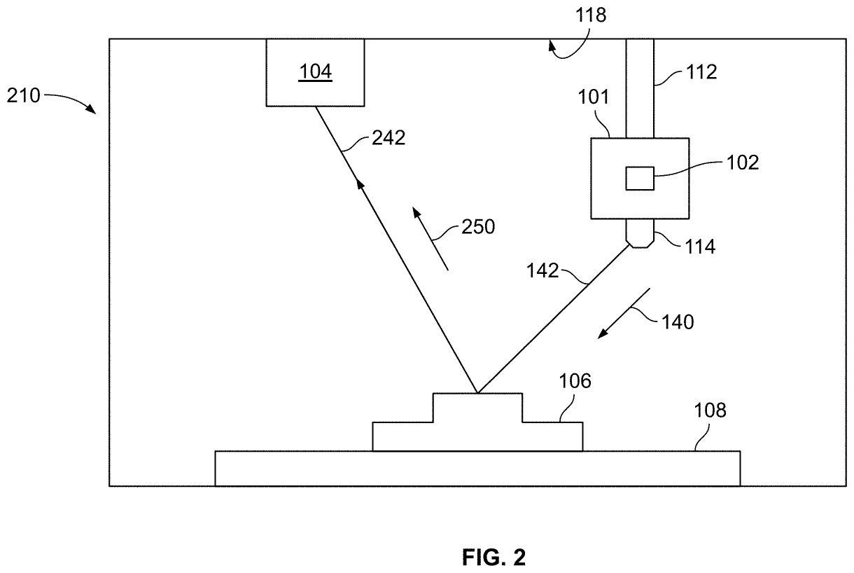

Alternatively, the optical sensor 104, or one or more circuits or controllers of the optical sensor 104, may be disposed in an alternative location. For example, FIG. 2 illustrates an alternative embodiment of the additive manufacturing system 210. In the illustrated embodiment of FIG. 2, the optical device 102 is disposed within the laser head 101. The optical device 102 emits light 142 via the laser source 114 in the direction 140 toward the object 106 disposed on or within the build area 108. Reflected light 242 of the emitted light 142 is reflected off of the build area 108 and the object 106 in a reflection direction 250 toward the optical sensor 104. Alternatively, the optical device 102 may emit light in any alternative direction relative to the object and in a direction toward the build area 108 and the object 106, and the optical sensor 104 may be disposed in any alternative position to receive the reflected light that is reflected off of the object 106 and/or the build area 108.

In one or more embodiments, one or more surfaces of the object 106 and/or the build area 108 may be prepared prior to the optical device 102 emitting light 142. As one example, a top surface (e.g., the surface that the optical device may direct light towards) and/or one or more side surfaces of the object may be prepared in order to improve an amount and/or a quality of the reflected light 242 that is directed toward the optical sensor. The surfaces may be treated, engineered, modified, or the like, such as by being roughened, textured, or the like. For example, a surface of the object may be treated with one or more deposition and/or diffusion techniques that may change or alter the one or more surfaces of the object, the surface of the build area, or the like.

In the illustrated embodiment of FIG. 1, the laser head 101 is coupled with the surface 118 of the housing, and the build area 108 is coupled with an opposite surface 119. Optionally, the build area 108 may be on a surface that may be substantially parallel to the surface 118. Optionally, the system 110 may have any alternative configuration or orientation.

The system 100 can include a workstation 122 that is separate from the housing 116. The workstation 122 may include a graphical user interface or GUI 124, a control system 126, one or more input and/or output devices 128 (e.g., a keyboard, electronic mouse, printer, voice controllers, or the like), and a communication system 132. The workstation 122 may include data processing circuitry, where additional processing and analysis may be performed. For example, the one or more processors may be one or more computer processors, controllers (e.g., microcontrollers), or other logic-based devices that perform operations based on one or more sets of instructions (e.g., software). An operator of the system 100 may remotely control the additive manufacturing system 110 from the workstation. For example, the operator may control one or more settings of the additive manufacturing system 110 by manipulating one or more components of the workstation 122.

In one embodiment, the operator may control operating settings of the optical device 102 and/or the optical sensor 104 via the workstation 122, and the workstation 122 may communicate the commands with a transceiver 138 of the system 110 via the bidirectional communication link 120. The bi-directional communication link 120 between the workstation 122 and the transceiver 138 may be a wired connection or a wireless connection. Suitable communication models include wireless, such as the bi-directional communication link 120, or wired. The wireless communication modalities may be used based on application specific parameters. Nonlimiting examples include near field communication (NFC), Bluetooth, Wi-Fi, 3G, 4G, 5G, and others. For example, where there may be electromagnetic field (EMF) interference, certain modalities may work where others may not.

In one or more embodiments, the additive manufacturing system 110 may also include a system controller 130. The system controller 130 may include a graphical user interface or GUI 134, one or more input and/or output devices 136 (e.g., keyboard, electronic mouse, printer, or the like), and the transceiver 138. An operator of the system 100 may control the additive manufacturing system 110 by controlling one or more components of the system controller 130.

In one or more embodiments, the optical sensor 104 may detect a change in the reflection of the light off the surface that may indicate the presence of an edge of the object 106. The edge of the object 106 may be transverse to a scanning direction 145 of the optical device 102, perpendicular to the scanning direction, or the like. For example, the scanning direction 145 may be in one or more directions that are substantially parallel to a surface of the object 106. For example, the scanning direction 145 may be any rastering path of the light that moves over the build area and the object 106. Optionally, the edge of the object 106 may not be perpendicular to the energy deposition direction 140 of the optical device 102. For example, the edge of the object may be formed by two different surfaces of the object that extend in two different orthogonal directions relative to each other. The edge may be a corner or seam between two surfaces that extend in substantially perpendicular directions, or alternative may be a seam between two surfaces that extend in non-perpendicular directions. Optionally, the light 142 may be directed from the optical device in one or more radial directions relative to the laser source 114, such as illustrated in FIG. 2. The optical sensor 104, or one or more processors of the system controller 130 and/or the workstation 122, may determine a beam width or a power spatial distribution of the light 142 based on the optical sensor 104 detecting the reflection of the light off of the edge of the object 106.

In one or more embodiments, the optical sensor 104 may determine a position of the light (e.g., relative to a position of a scanning area, a nominal position of the build area 108, or the like), based on the reflection of the light off the object 106. For example, the optical sensor 104 may determine the position of the light based on reading one or more controlled positions of the optical device 102. Optionally, the optical sensor 104 may determine the position of the light based on one or more of a trajectory of the light 142, a traverse velocity of the light 142, a scan area of the light 142, and/or a sampling rate of the optical sensor 104. Optionally, the optical sensor 104 may determine the position of the light based on an alternative method or combination of methods.

The optical device 102 may operate at different operating settings, such as at a low or lower energy optical setting or at a high or higher energy optical setting. For example, while the optical device 102 is operating at the lower energy optical setting, the optical device 102 may emit the laser or light 142 having a first power level (e.g., a first energy level, or the like). Alternatively, while the optical device 102 is operating at the higher energy optical setting, the optical device 102 may emit the laser or light 142 having a second power level that is greater than the first power level (e.g., a second energy level that is greater than the first energy level, or the like).

In one or more embodiments, the additive manufacturing system 110 may operate at a first operating setting or at a second operating setting. While the system 110 is operating at the first operating setting, the optical device 102 may emit the light 142 toward the build area 108 and the object 106. The optical sensor 104 may receive the reflected light of the emitted light 142 that is reflected off of the build area 108 and the object 106 that is disposed on or within the build area 108. The optical sensor 104 can measure the intensity of the reflection of the light off of the build area 108 and the object 106 to determine a position of the object 106 or a shape of the object 106 on and/or within the build area 108 based on the intensity of the reflection for a calculated and/or known light position. For example, the optical sensor 104 may determine a multi-dimensional shape of the object (e.g., a two-dimensional shape, and/or three-dimensional shape of the object, or the like), may determine contours of different surfaces of the object relative to other surfaces of the object, may determine contours of the object relative to a scanning area (shown in FIG. 4), may determine a position, an orientation, a shape, and/or a size of internal features of the object 106 (e.g., channels, holes, passages, or the like), or the like. Optionally, the system 110 may operate at the first operating setting for one or more alternative purposes.

Alternatively, the system 110 may operate at the second operating setting. While the system 110 is operating at the second operating setting, the optical device 102 may emit the light 142 toward the build area 108 and the object 106. The light 142 may be used to additively form a component or feature onto the object 106 that is disposed on or within the build area 108. For example, the system 110 may additively print or form a component onto the object 106 to create a unitary embodiment of the component and the object 106. Optionally, the system 110 may additively print or form a secondary component that is separate from the object 106 but may be strategically located within the build area 108 relative to the position of the object 106. Optionally, the system 110 may additively print or form a component onto the object 106 to repair one or more features and/or surfaces of the object 106. Optionally, the object 106 may be a generic design, and the system 110 may additively print or form onto the object 106 to create a specific design of the object. Optionally, the system 110 may be operated at the second operating setting for one or more alternative purposes.

Additively forming the component or feature onto the object using the light 142 emitted from the optical device 102 can involve joining or solidifying material under computer control to create a three-dimensional object, such as by adding liquid droplets or fusing powder grains with each other. Examples of additive manufacturing include three-dimensional (3D) printing, rapid prototyping (RP), direct digital manufacturing (DDM), selective laser melting (SLM), electron beam melting (EBM), direct metal laser melting (DMLM), directed energy deposition (DED), or the like.

FIG. 3 illustrates a side-wise view of a system 310 that may be a galvanometer-based system such as a laser powder bed fusion (LPB-F) system. The system 310 includes the optical device 102 that is disposed within a laser head 101. The system 310 also includes at least one optical sensor 104 that is disposed outside of the laser head 101. While operating at a first operating setting, the optical device 102 emits the light 142 in a direction toward one or more reflective devices, such as mirrors 308. Position of the mirrors 308 may dynamically change while the optical device 102 emits the light 142 to direct the light in one or more different energy deposition directions 140 toward the build area 108. For example, changing the position of the mirrors changes the energy deposition direction 140 as the optical device 102 scans the build area 108, a part of the build area 108, a scanning area, or the like. Additionally, changing the position of the mirrors moves the light 142 along one or more X-directions and Y-directions along the scanning direction 145. The reflected light 242 of the emitted light 142 is reflected off of the build area 108 and the object 106 in the reflection direction 250 toward the optical sensor 104.

The system 310 may also include a powder dispenser 312, a powder bed 314, a powder collector 316, and one or more re-coater arms 318. For example, while operating at a second operating setting, the system 310 may form or build a component onto the object 106 by the powder dispenser 312 dispensing power onto the powder bed 314, and the powder collector 316 may collect or otherwise obtain excess powder.

FIG. 4 illustrates a top view of the system 110 shown in FIG. 1 in accordance with one embodiment. The object 106 is disposed on and within the build area 108. A scanning area 304 is set as a dummy single layer part by an operator of the system 100. The scanning area 304 may be a predetermined area or space that is disposed within the build area 108. In the illustrated embodiment, the scanning area 304 is substantially rectangular, however the scanning area 304 may have any alternative shape and/or size. In one or more embodiments, a dummy part may be designed having any shape and/or size that is within the build area 108. The system 110, operating at the first operating setting, may emit the light in a direction toward the dummy part within the build area 108. The optical sensor may receive and measure an intensity of the reflected light. The intensity of the reflected light, along with the known and/or calculated scan parameters, may be used to determine an actual position of the object 106, or a portion of the object 106, within the build area 108.

The optical device 102 emits the light 142 shown in FIGS. 1, 2, and 3 in a direction toward the build area 108. In one embodiment, the laser head 101 may move in one or more different directions to move the laser source 114 and the corresponding light 142 that is emitted from the laser source 114 within the scanning area 304. For example, the laser head 101 may move in different directions to move the laser or emitted light 142 in a scanning pattern 302. Alternatively, as illustrated in FIG. 3, the laser head 101 may remain stationary, and one or more mirrors 310 or an alternative reflection device may move to direct the light in the scanning pattern 302. The scanning pattern 302 may represent a laser rastering path. In the illustrated embodiment, the scanning pattern 302 has a back-and-forth configuration (e.g., in both a Y-direction and X-direction) that begins at a first side of the scanning area 304 and has a substantially uniform interval along the X-direction. Optionally, the scanning pattern 302 may have any alternative patterned configuration, random configuration, or a combination of random and pattern configurations along the rastering path. In one or more embodiments, the optical device 102 may emit light in the build path according to the scanning pattern 302 over the entire scanning area 304. Optionally, the optical device 102 may emit light according to the scan pattern 302 over a portion of the build area 108, over substantially all of the build area 108, or the like. Optionally, the laser head 101 and the laser source 114 may remain stationary, and the build area 108 may move relative to the laser source 114.

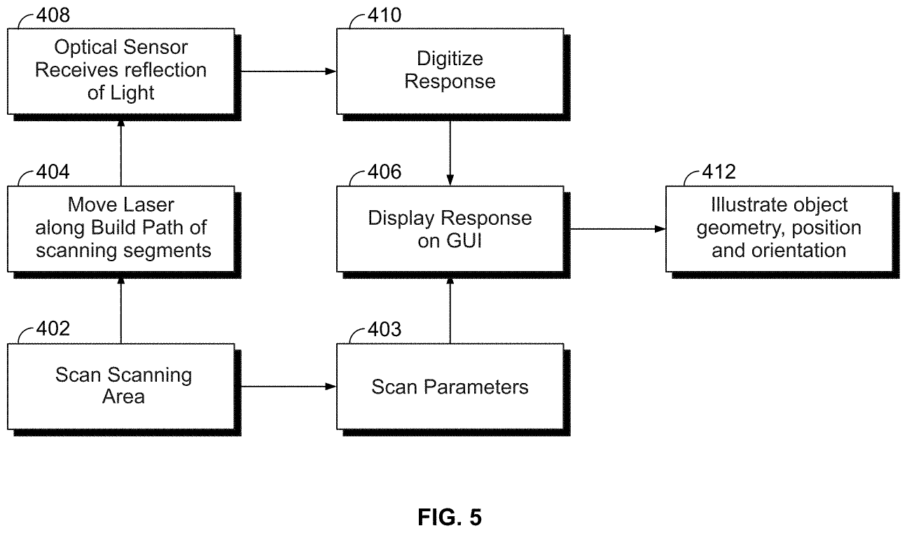

FIG. 5 illustrates a diagram of a potential workflow for operating the system 110 and/or 310 at first operating settings. The work piece or object 106 may be positioned on or within the build area 108. At 402, the scanning area 304 may be determined, positioned, or the like, as a dummy part by an operator of the system 100, or may be a predetermined area 304 that may be preset, controlled, or known by one or more processors of the system controller 130. At 403, known and/or calculated scanning parameters may be determined from the setting of the dummy part. The scanning parameters may include one or more characteristics of the system including, but not limited to, a trajectory of the light (e.g., X-dimensions and/or Y-dimensions of the scanning path 302), hatching steps, the pattern of the scanning path 302, a velocity of movement of the light 142 according to the scanning path 302, a sampling rate of the optical sensor, a size of the scan area, or the like. Based on the intensity response determined by the optical sensors 104, and the one or more known and/or calculated parameters, at 406, the GUI 124 of the workstation 122 and/or the GUI 134 of the system controller 130 may display the image response as the optical device 102 scans the scanning area 304 with the laser or emitted light 142. The image may be displayed substantially simultaneously as the optical device 102 is operating at the first operating settings, or the image may be displayed after a portion of the scanning area 304 is scanned, after the whole scanning area 304 is scanned, or the like. At 412, the image may illustrate the geometry of the object 106 disposed on and/or within the build area 108, the position of the object 106 relative to the build area 108 and/or the scanning area 304, and the orientation of the object 106 relative to nominal build coordinates used to define the dummy part.

Additionally or alternatively, at 404, the system 110 begins operating according to the first operating settings. The system 110 begins to scan the scanning area 304 in the scanning pattern 302 or rastering path such that the laser or emitted light 142 may move in any pattern and/or random configuration. The laser source 114 emits the laser or light 142 in the energy deposition direction 140 toward the scanning area 304. At 408, the optical sensor 104 receives the reflection of the light emitted from the optical device 102 and transmits the response to an A/D convertor of the system controller 130. At 410, the signal response representing the reflection of light may be digitized. For example, one or more processors of the system controller 130 and/or the workstation 122 may receive data related to the build path of the scanning pattern 302 and the reflection response. The build path and the reflection response may be stitched together to create a unitary representation of the object 106 within the scanning area 304. At 406, an image may be generated and displayed via the GUI 124 of the workstation 122 and/or the GUI 134 of the system controller 130. At 412, the image may illustrate the geometry of the actual object 106 disposed on and/or within the build area 108, the location of the object 106 relative to the scanning area 304 and/or the build area 108, and the position and/or orientation of the object 106 relative to nominal build coordinates that may be used to define the dummy part.

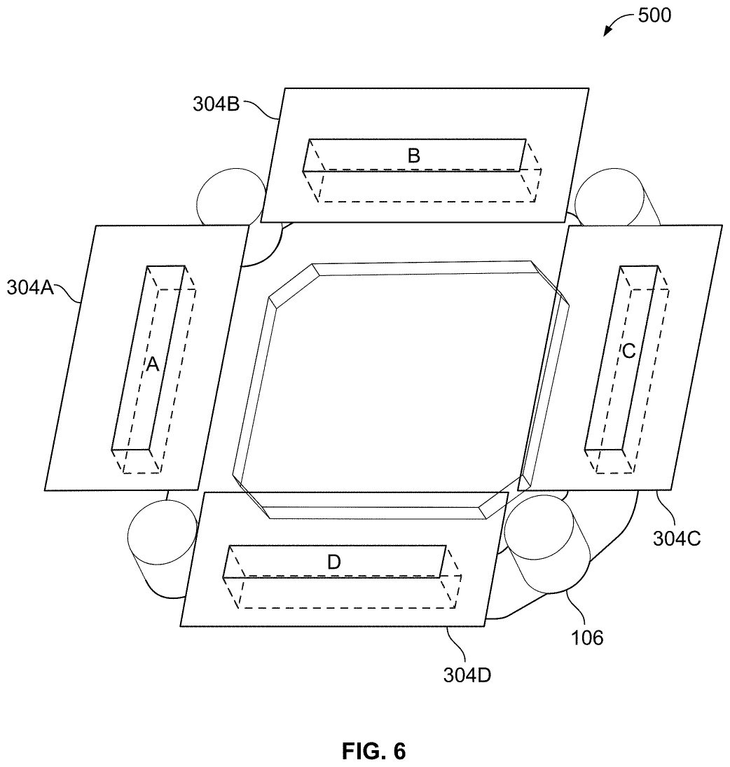

FIG. 6 illustrates one example of operating the system at the first operating settings. The system may scan plural different scanning areas 304A-D to determine the actual position of the object 106. For example, an image 500 that includes the geometry, orientation, and position of the object 106 may be displayed to the operator via the GUI 134 of the system controller 130 and/or the GUI 124 of the workstation 122. The image 500 may be divided into the plural different scanning areas 304A-D to determine an actual position of the features A, B, C, and D of the object 106. In the illustrated embodiment, the image 500 is divided into four different and substantially similar shape and size scan sections. For example, the system may operate at the first operating settings and scan each of the individual scanning areas 304A-D to capture the features A, B, C, and D of the object 106 disposed on the build area. Optionally, the image 500 may only scan within the scanning areas 304A. For example, a component may need to be printed or otherwise coupled with a portion of the object 106 that may be within the scanning area 304A. Optionally, scanning area 304A may include one or more features of the object 106 that may be used to verify an accurate position of the object 106. Alternatively, the image 500 may be a single scan section. For example, an entire surface of the object 106 may be scanned within a single scanning area 304. Optionally, the image 500 may be divided into any number of scanning areas having any common or unique shape and/or size relative to each other scan section.

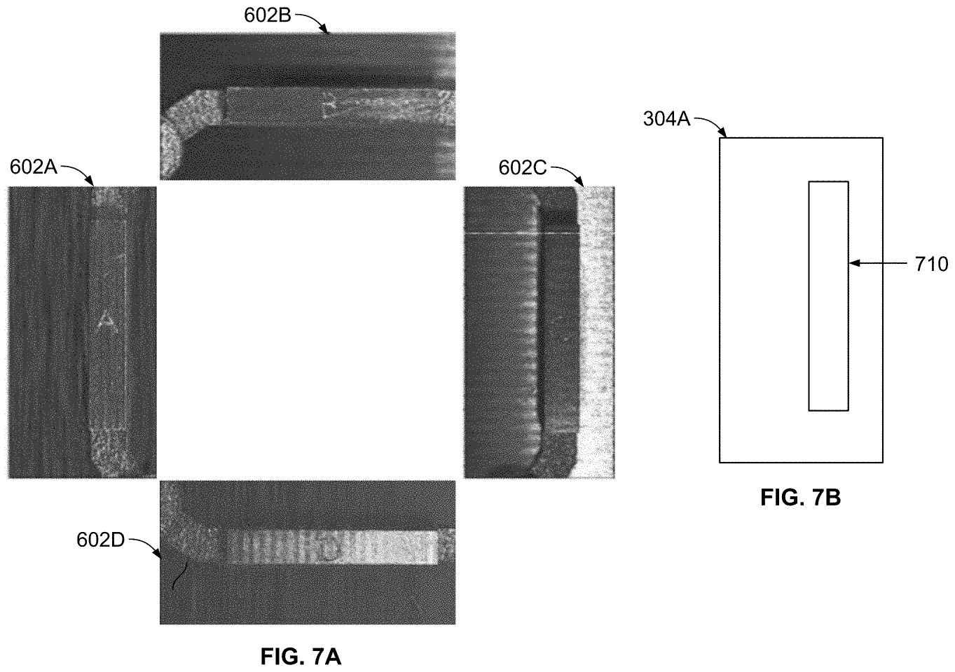

FIG. 7A illustrates one example of images 602A-D of the scanning areas 304A-D shown in FIG. 6 in accordance with one embodiment. The images 602A-D are two-dimensional images that may represent and indicate an intensity of the reflected light received by the optical sensor 104. For example, a position and geometry of each section of the object 106 is represented within the respective image 602A-D. The system 100 may determine a position of the object 106 based on the intensity of the reflection of the light off of the object 106 disposed on or within the build area 108. Additionally, FIG. 7B illustrates one of the scanning areas 304A shown in FIG. 7A. As shown in FIG. 7B, a portion 710 of the object may indicate an actual position of the portion 710 (e.g., the feature A) of the object 106 within the scanning area 304A.

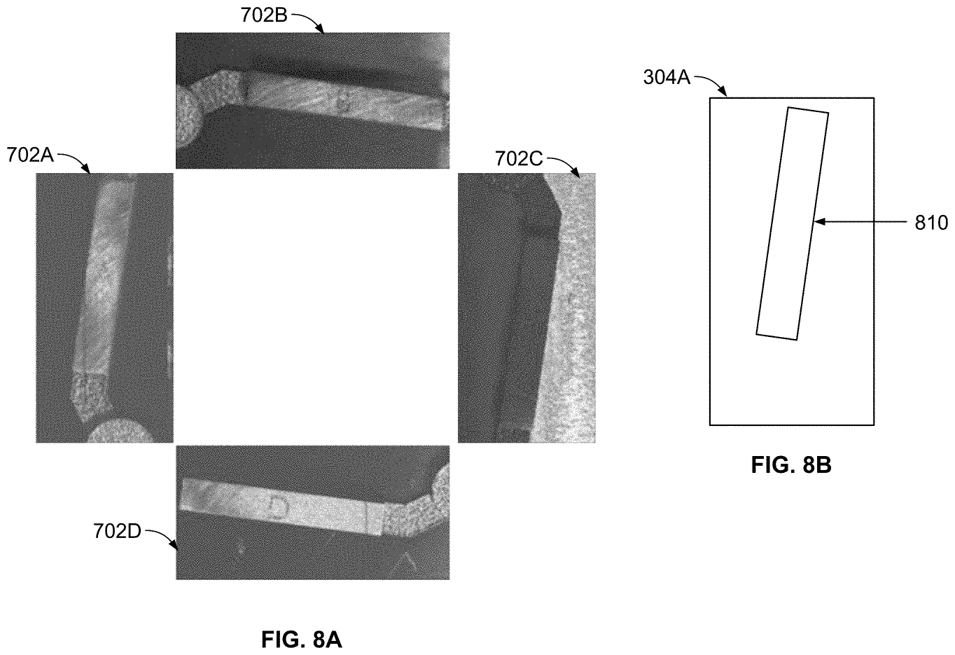

Alternatively, FIG. 8A illustrates another example of images 702A-D of the scanning areas shown in FIG. 6. The images 702A-D may correspond to the images 602A-D, respectively. As illustrated in FIG. 8A, the position of the object 106 is rotated relative to the position of the object 106 illustrated in FIG. 7A. For example, images 702A-D illustrate that the position of the object 106 may be determined based on the intensity of the reflection of the light. Additionally, FIG. 8B illustrates one of the scanning areas 304A shown in FIG. 8A. As shown in FIG. 8B, a portion 810 of the object may indicate an actual position of the portion 810 (e.g., the feature A) of the object 106 within the scanning area 304A. Relative to the portion 710 illustrated in FIG. 7B, the portion 810 of the object is rotated within the scanning area 304A.

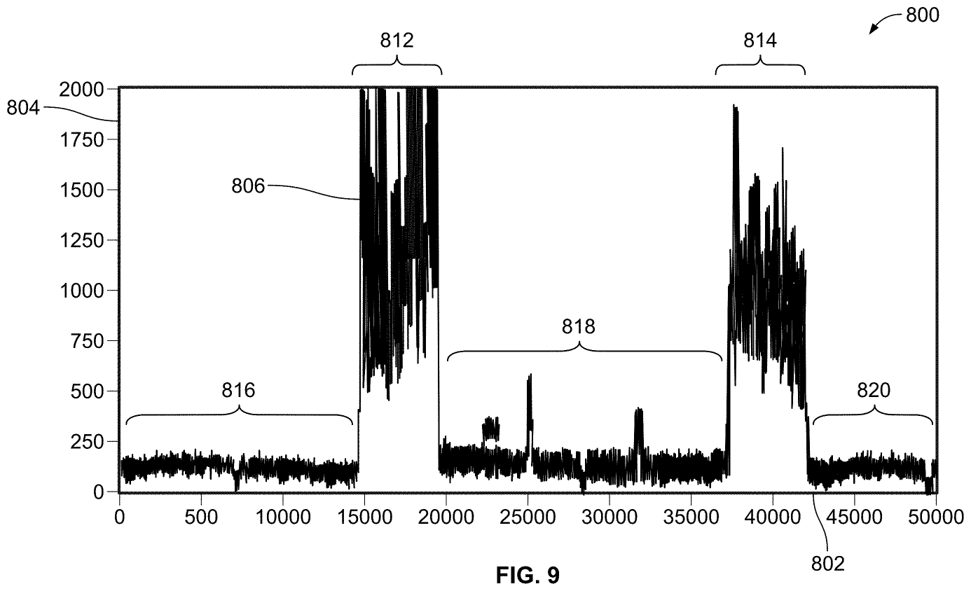

FIG. 9 illustrates a graph 800 related to measuring a scanning area. The graph 800 illustrates one example of a line 806 shown alongside a horizontal axis 802 representative of time, and a vertical axis 804 representative of increasing light intensity. For example, the graph 800 may represent an optical sensor amplitude versus distance of the reflective light according to one or more of a size and/or dimensions of a scanning area, an input of a velocity of light moving according to the scanning pattern 302, or the like. The line 806 represents the intensity of the light 142 emitted from the optical device 102 and reflected off of the build area 108 and object 106 disposed within the build area 108. Sections 812 and 814 indicate reflection of light off the object 106, specifically, from feature A of the object 106. Alternatively, sections 816, 818, 820 indicate reflection of light off the build area 108.

While the optical device 102 operates at the first operating settings, the optical sensor 104 receives reflection of the light emitted from the optical device 102 and reflected off the build area 108 and the object 106 to determine a position, a shape, an orientation, or the like, of the object 106. For example, the optical sensor 104 can measure an intensity of the reflection of the light when the optical device 102 is operating at the first operating settings. In one embodiment, the optical device 102 is operating at a lower energy level when the optical device 102 is operating at the first operating settings. For example, the optical device 102 may emit the light having a reduced power or lower power level when the optical device 102 is operating at the first operating settings to determine the position, orientation, and/or shape of the object 106. Alternatively, the optical device 102 may operate at a higher energy level (e.g., higher temperature, higher power, or the like) when the optical device 102 is operating at the first operating settings such that the optical device 102 may emit the light having an elevated power.

Subsequent to the optical sensor 104 determining the position, shape, and/or orientation of the object 106, the optical device 102 may operate at the second operating setting to emit the light 142 to additively form onto the object 106 disposed on and/or within the build area 108. The light 142 may be used to heat, melt, or the like, a material that may be used to additively form onto the object 106. For example, the emitted light 142 may be used to additively form a component (not shown) or feature onto the object 106 that may form a unitary structure of the component and the object 106. Optionally, the emitted light 142 may be used to additively form a component that is separate to the object 106. The component may be made of a material that is common or have similar and/or compatible properties as the material of the object. For example, the component and the object may be made of a common metal or metal alloy, different materials (e.g., a plastic and a metallic material), or any combination therein.

In one embodiment, the optical device 102 may operate at a higher energy level when the optical device 102 is operating at the second operating settings relative to when the optical device 102 is operating at the first operating settings. For example, the optical device 102 may emit the light 142 having an elevated power to additively form onto the object 106. Additionally, the optical device 102 may emit the light having a reduced power when the optical device 102 is operating at the first operating setting, and emit the light 142 having an elevated power when the optical device 102 is operating at the second operating setting.

Optionally, the optical device 102 may operate at a lower energy level when the optical device is operating at the second operating settings relative to when the optical device 102 is operating at the first operating settings. Optionally, the optical device 102 may operate at a common energy level when the optical device 102 is operating at the first and second operating settings.

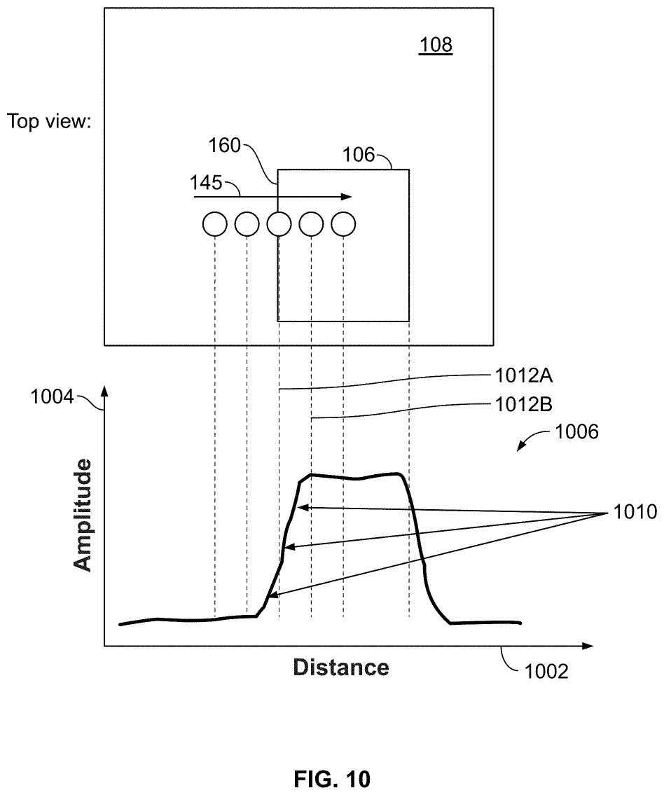

FIG. 10 illustrates a top view of a moving laser beam and an optical sensor signal profile 1006 in accordance with one embodiment. For example, FIG. 10 may illustrate one example of determining a beam width, a power spatial distribution, or the like, based on determining the optical sensor signal profile 1006 The optical sensor signal profile 1006 is shown as a graph that includes a horizontal axis 1002 representative of distance, and a vertical axis 1004 representative of an increasing amplitude of the optical sensor 104. The emitted light 142 moves in the scanning direction 145 from a position within the build area 108 but away from the object 106 toward a position containing a portion of the object 106.

As the emitted light moves in the scanning direction 145 and moves over an edge 160 of the object 106, a signal 1010 changes. The signal 1010 does not change simultaneously to the light moving over the edge of the object 106 due to a finite beam diameter (e.g., of a range from about 60 microns to about 100 microns, or any other size range). For example, emitted light at a point 1012A is about at the edge 160, however, the amplitude of the signal 1010 does not increase until the emitted light reaches a point 1012B within the object 106 and a distance away from the edge 160. The transition distance of the changing intensity of the reflected light can be used to determine a diameter and/or size of the beam of the light. For example, an increasing beam diameter may have a slower transition of increasing amplitude at the laser beam moves over the edge 160 of the object 106.

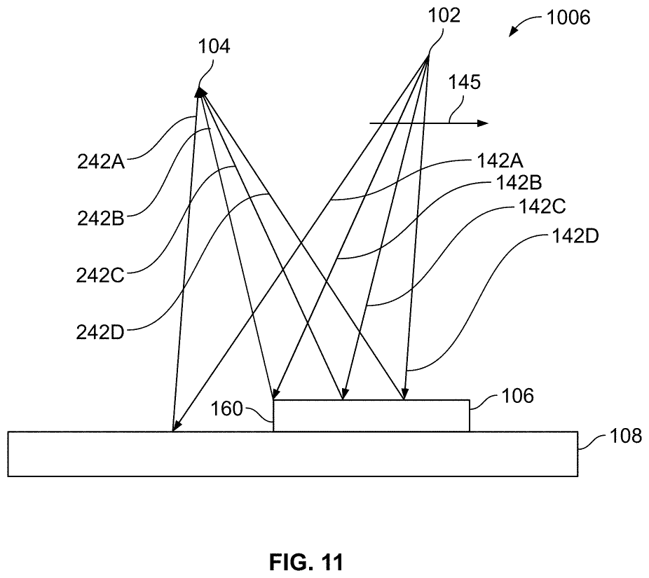

Additionally, FIG. 11 illustrates a side view of the moving laser beam that corresponds to the top view shown in FIG. 10. The optical device 102 emits the light 142 toward the object 106 disposed within the build area 108. A first emitted light 142A is received by the optical sensor 104 as a first reflected light 242A, a second emitted light 142B is received by the optical sensor 104 as a second reflected light 242B, a third emitted light 142C is received by the optical sensor 104 as a third reflected light 242C, and a fourth emitted light 142D is received by the optical sensor 104 as a fourth reflected light 242D.

The first emitted light 142A hits a position of the build area 108. The second emitted light 142B hits the edge 160 of the object 106. However, based on the size of the laser beam of the emitted light 142B, the intensity of the signal (illustrated in FIG. 10) does not increase until about when the optical sensor receives the third reflected light 242C.

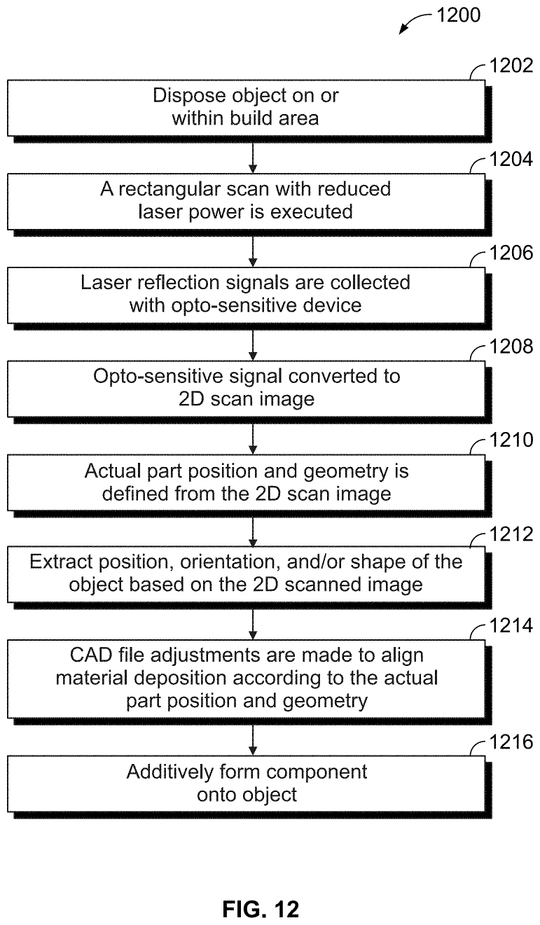

FIG. 12 illustrates one example of a flowchart of a method 1200 of determining a position, an orientation, or a shape of the object 106 and additively forming onto the object 106 in accordance with one embodiment. In the embodiment of the method 1200, the steps 1202 through 1210 may be performed while the optical device is operating at the first operating settings, and step 1216 may be performed while the optical device is operating at the second operating settings.

At 1202, an object that includes a surface, face, or component of the object that is to be additively formed onto is placed in the additive manufacturing system on or within the build area 108. For example, the surface of the object that is to be additively formed is aligned with a nominal position within the build area 108. In one or more embodiments, the object may include one or more damaged surfaces, components, features, or the like. Optionally, the object may be a generic design of the object, and one or more unique or custom features may need to be additively formed onto the object.

At 1204, a scanning area (shown in FIG. 4) may be selected by the operator or automatically by one or more processors of the system controller 130 or the workstation 122. The optical device 102 may emit the light 142 in an energy deposition direction 140 toward the build area 108. The optical device 102 may control the laser source 114 to move the light 142 in a scanning direction 145 according to one or more laser rastering paths (e.g., scanning pattern 302).

At 1206, the one or more optical sensors 104 receive reflection of the light emitted from the optical device 102. For example, the optical sensor 104 may collect the reflections of the light substantially simultaneously as the optical device 102 emits the light. At 1208, the reflections may be converted into one or more two-dimensional images. In one or more embodiments, the images may be separated into one or more different scanning areas (e.g., 602A-D shown in FIG. 7A). In one or more embodiments, the images may be displayed to an operator of system 100. And at 1210, the position, shape, and orientation of the object are determined based on the intensities of the reflected light and one or more known and/or calculated parameters, such as, but not limited to, a trajectory of the light (e.g., X-dimension and Y-dimension of the scanning pattern 302), a velocity of the movement of light according to the scanning pattern 302, a scan area of the light, a sampling rate of the optical sensor, or the like.

In one or more embodiments, at 1212, an extracted position, orientation, and/or shape of the object may be provided, created, generated, or the like, based on the 2D scanned image. For example, one or more software programs or other software approaches may be used to align, modify, adjust, or otherwise provide alignment information to the operator of the system. As one example, a datum reference scheme may be used. Another example of an alignment scheme may be a best-fit alignment practice. Optionally, the position, orientation, and/or shape of the object may be aligned, orientated, extracted, or the like, by any alternative practice.

At 1214, adjustments may be made to a computer-aided-design (CAD) file of the component to be additively formed onto the object. The adjustments may be made based on the position, shape, and/or orientation of the object that are determined. In one embodiment, the operator of the system 100 may change one or more settings of the CAD file of the component based on position, shape, and/or orientation of the object in the build area 108. Optionally, one or more processors may automatically make the adjustments to the CAD file.

At 1216, while the optical device 102 operates at the second operating setting, the component is additively formed onto the object 106. For example, a new surface and/or feature may be additively formed onto a damaged object to correct or fix the damaged object. Optionally, a new feature or component may be additively formed onto a base object to add one or more custom features onto the base object.

In one or more embodiments of the subject matter described herein, a system includes an optical device configured to emit light toward a build area, and an optical sensor configured to detect reflection of the light off one or more of the build area or an object disposed on or within the build area. The optical device operates at a first operating setting or at a second operating setting. The optical sensor receives reflection of the light emitted from the optical device operating at the first operating setting and reflected off one or more of the build area or the object to determine one or more of a position, an orientation, or a shape of the object disposed on or within the build area. The optical device operates at the second operating setting to emit the light to additively form onto the object disposed on or within the build area.

Optionally, the optical sensor is a photosensor or any other type of photodetector.

Optionally, the optical sensor measures an intensity of the reflection of the light off the build area when the optical device is operating at the first operating setting. The first operating setting includes the optical device operating at a lower energy level.

Optionally, the optical sensor determines a position of the object disposed on or within the build area based on the intensity of the reflection of the light off the build area.

Optionally, the optical sensor measures an intensity of the reflection of the light off the build area when the optical device is operating at the first operating setting, wherein the first operating setting includes the optical device operating at a higher energy level.

Optionally, the optical device emits the light having an elevated power to additively form onto the object disposed on or within the build area.

Optionally, the optical device emits the light having a reduced power to determine one or more of the position, the orientation, or the shape of the object disposed on or within the build area.

Optionally, the optical device emits the light having a reduced power when the optical device is operating at the first operating setting, and the optical device is configured to emit the light having an elevated power when the optical device is operating at the second operating setting.

Optionally, the optical sensor determines one or more of a position, an orientation, or a shape of one or more components within the build area when the optical device is operating at the first operating setting.

Optionally, the optical device operates at the second operating setting to emit the light to additively form a component onto the object disposed on or within the build area.

Optionally, the optical device operates at the second operating setting to emit the light to additively form the component onto the object disposed on or within the build area to form a unitary structure of the component and the object.

Optionally, one or more surfaces of the object may be configured to be prepared via one or more surface modification processes to improve a quality of the reflection of the light configured to be reflected off one or more of the build area or the object disposed on or within the build area.

In one or more embodiments of the subject matter described herein, a method includes operating an optical device of a system at a first operating setting or at a second operating setting. The system includes the optical device that emits light toward a build area, and an optical sensor that detects reflection of the light off one or more of the build area or an object disposed on or within the build area. The optical sensor receives reflection of the light emitted from the optical device operating at the first operating setting and reflected off one or more of the build area or the object to determine one or more of a position, an orientation, or a shape of the object disposed on or within the build area. The optical device operates at the second operating setting to emit the light to additively form onto the object disposed on or within the build area.

Optionally, the optical sensor is a photosensor or any other type of photodetector.

Optionally, the method also includes measuring an intensity of the reflection of the light off the build area with the optical sensor when the optical device is operating at the first operating setting, wherein the first operating setting includes the optical device operating at a lower energy level.

Optionally, the method also includes determining a position of the object disposed on or within the build area with the optical sensor based on the intensity of the reflection of the light off the build area.

Optionally, the method also includes measuring an intensity of the reflection of the light off the build area with the optical sensor when the optical device is operating at the first operating setting, wherein the first operating setting includes the optical device operating at a higher energy level.

Optionally, the optical device is configured to emit the light having an elevated power to additively form onto the object disposed on or within the build area.

Optionally, the optical device is configured to emit the light having a reduced power to determine one or more of the position, the orientation, or the shape of the object disposed on or within the build area.

Optionally, the optical device is configured to emit the light having a reduced power when the optical device is operating at the first operating setting, and the optical device is configured to emit the light having an elevated power when the optical device is operating at the second operating setting.

Optionally, the method also includes determining one or more of a position, an orientation, or a shape of one or more components within the build area when the optical device is operating at the first operating setting.

Optionally, the optical device is configured to operate at the second operating setting to emit the light to additively form a component onto the object disposed on or within the build area.

Optionally, the optical device is configured to operate at the second operating setting to emit the light to additively form the component onto the object disposed on or within the build area to form a unitary structure of the component and the object.

Optionally, the optical sensor is configured to operate at a high sampling frequency and the optical device is configured to emit the light onto the build area at a constant scanning velocity.

Optionally, the optical sensor is configured to detect the reflection of the light off an edge of the object, wherein the edge of the object is transverse to a scanning direction of the optical device.

Optionally, the method also includes determining one or more of a beam width or a power spatial distribution of the light based on the optical sensor detecting the reflection of the light off the edge of the object.

Optionally, the method may also include determining a position of the light based on one or more of an intensity of the reflection of the light or one or more parameters of the light emitted from the optical device.

Optionally, the method may also include determining the position of the light based on reading one or more controlled positions of the optical device.

Optionally, the one or more parameters include one or more of a trajectory, velocity, a scan area of the light, or a sampling rate of the optical sensor.

In one or more embodiments of the subject matter described herein, an optical additive manufacturing system includes an optical device configured to emit light toward a build area, and an optical sensor configured to detect reflection of the light off one or more of the build area or an object disposed on or within the build area. The optical device is configured to operate at a first operating setting or at a second operating setting. When the optical device is operating at the first operating setting, the optical device is configured to operate at a first energy level such that the optical device is configured to emit light having a first power. The optical sensor is configured to receive reflection of the light emitted from the optical device and reflected off one or more of the build area or the object to determine one or more of a position, an orientation, or a shape of the object disposed on or within the build area when the optical device is operating at the first operating setting. When the optical device is operating at the second operating setting, the optical device is configured to operate at a second energy level such that the optical device is configured to emit light having an elevated power that is greater than the first power. The optical device is configured to operate at the second operating setting to emit the light to additively form onto the object disposed on or within the build area.

As used herein, an element or step recited in the singular and proceeded with the word “a” or “an” should be understood as not excluding plural of said elements or steps, unless such exclusion is explicitly stated. Furthermore, references to “one embodiment” of the presently described inventive subject matter are not intended to be interpreted as excluding the existence of additional embodiments that also incorporate the recited features. Moreover, unless explicitly stated to the contrary, embodiments “comprising,” “including,” or “having” (or like terms) an element, which has a particular property or a plurality of elements with a particular property, may include additional such elements that do not have the particular property.

As used herein, terms such as “system” or “controller” may include hardware and/or software that operate(s) to perform one or more functions. For example, a system or controller may include a computer processor or other logic-based device that performs operations based on instructions stored on a tangible and non-transitory computer readable storage medium, such as a computer memory. Alternatively, a system or controller may include a hard-wired device that performs operations based on hard-wired logic of the device. The systems and controllers shown in the figures may represent the hardware that operates based on software or hardwired instructions, the software that directs hardware to perform the operations, or a combination thereof.

As used herein, terms such as “operably connected,” “operatively connected,” “operably coupled,” “operatively coupled,” “operationally contacted,” “operational contact” and the like indicate that two or more components are connected in a manner that enables or allows at least one of the components to carry out a designated function. For example, when two or more components are operably connected, one or more connections (electrical and/or wireless connections) may exist that allow the components to communicate with each other, that allow one component to control another component, that allow each component to control the other component, and/or that enable at least one of the components to operate in a designated manner.

It is to be understood that the subject matter described herein is not limited in its application to the details of construction and the arrangement of elements set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the presently described subject matter without departing from its scope. While the dimensions, types of materials and coatings described herein are intended to define the parameters of the disclosed subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
an optical device configured to emit light toward a build area; and
an optical sensor configured to detect reflection of the light off one or more of the build area or an object disposed on or within the build area,
wherein the optical device is configured to operate at a first operating setting or at a second operating setting, the optical sensor configured to receive reflection of the light emitted from optical device operating at the first operating setting and reflected off one or more of the build area or the object to determine one or more of a position, an orientation, or a shape of the object disposed on or within the build area, the optical device configured to operate at the second operating setting to emit the light to additively form onto the object disposed on or within the build area.

2. The system of claim 1, wherein the optical sensor is a photosensor or any other type of photodetector.

3. The system of claim 1, wherein the optical sensor is configured to measure an intensity of the reflection of the light off the build area when the optical device is operating at the first operating setting, wherein the first operating setting includes the optical device operating at a lower energy level.

4. The system of claim 3, wherein the optical sensor is configured to determine a position of the object disposed on or within the build area based on the intensity of the reflection of the light off the build area.

5. The system of claim 1, wherein the optical sensor is configured to measure an intensity of the reflection of the light off the build area when the optical device is operating at the first operating setting, wherein the first operating setting includes the optical device operating at a higher energy level.

6. The system of claim 1, wherein the optical device is configured to emit the light having a reduced power when the optical device is operating at the first operating setting, and the optical device is configured to emit the light having an elevated power when the optical device is operating at the second operating setting.

7. The system of claim 1, wherein the optical sensor is configured to determine one or more of a position, an orientation, or a shape of one or more components within the build area when the optical device is operating at the first operating setting.

8. The system of claim 1, wherein the optical device is configured to operate at the second operating setting to emit the light to additively form a component onto the object disposed on or within the build area.

9. The system of claim 1, wherein one or more surfaces of the object are configured to be prepared via one or more surface modification processes to improve a quality of the reflection of the light configured to be reflected off one or more of the build area or the object disposed on or within the build area.

10. A method comprising:
operating an optical device of a system at a first operating setting or at a second operating setting, the system comprising the optical device configured to emit light toward a build area, the system comprising an optical sensor configured to detect reflection of the light off one or more of the build area or an object disposed on or within the build area, wherein the optical sensor is configured to receive reflection of the light emitted from the optical device operating at the first operating setting and reflected off one or more of the build area or the object to determine one or more of a position, an orientation, or a shape of the object disposed on or within the build area, the optical device configured to operate at the second operating setting to emit the light to additively form onto the object disposed on or within the build area.

11. The method of claim 10, further comprising measuring an intensity of the reflection of the light off the build area with the optical sensor when the optical device is operating at the first operating setting, wherein the first operating setting includes the optical device operating at a lower energy level.

12. The method of claim 11, further comprising determining a position of the object disposed on or within the build area with the optical sensor based on the intensity of the reflection of the light off the build area.

13. The method of claim 10, further comprising measuring an intensity of the reflection of the light off the build area with the optical sensor when the optical device is operating at the first operating setting, wherein the first operating setting includes the optical device operating at a higher energy level.

14. The method of claim 10, wherein the optical device is configured to emit the light having a reduced power when the optical device is operating at the first operating setting, and the optical device is configured to emit the light having an elevated power when the optical device is operating at the second operating setting.

15. The method of claim 10, further comprising determining one or more of a position, an orientation, or a shape of one or more components within the build area when the optical device is operating at the first operating setting.

16. The method of claim 10, wherein the optical device is configured to operate at the second operating setting to emit the light to additively form a component onto the object disposed on or within the build area.

17. The method of claim 10, wherein the optical sensor is configured to operate at a high sampling frequency and the optical device is configured to emit the light onto the build area at a constant scanning velocity.

18. The method of claim 10, wherein the optical sensor is configured to detect the reflection of the light off an edge of the object, wherein the edge of the object is transverse to a scanning direction of the optical device, and determine one or more of a beam width or a power spatial distribution of the light based on the optical sensor detecting the reflection of the light off the edge of the object.

19. The method of claim 10, further comprising determining a position of the light based on one or more of an intensity of the reflection of the light or one or more parameters of the light emitted from the optical device.

20. An optical additive manufacturing system comprising:
an optical device configured to emit light toward a build area; and
an optical sensor configured to detect reflection of the light off one or more of the build area or an object disposed on or within the build area,
wherein the optical device is configured to operate at a first operating setting or at a second operating settings,
wherein, when the optical device is operating at the first operating setting, the optical device is configured to operate at a first energy level such that the optical device is configured to emit light having a first power, wherein the optical sensor is configured to receive reflection of the light emitted from the optical device and reflected off one or more of the build area or the object to determine one or more of a position, an orientation, or a shape of the object disposed on or within the build area when the optical device is operating at the first operating setting, and
wherein, when the optical device is operating at the second operating setting, the optical device is configured to operate at a second energy level such that the optical device is configured to emit light having an elevated power that is greater than the first power, wherein the optical device is configured to operate at the second operating setting to emit the light to additively form onto the object disposed on or within the build area.
